(19) United States
(12) Patent Application Publication
(10) Pub. No.: US 2025/0310915 A1
(43) Pub. Date: Oct. 2, 2025

(54) COMMUNICATION SYSTEM AND SERVER THEREFOR

(71) Applicant: BROTHER KOGYO KABUSHIKI KAISHA, Nagoya (JP)

(72) Inventors: Lei SONG, Nagoya (JP); Katsuaki ITO, Nagoya (JP)

(21) Appl. No.: 19/089,053

(22) Filed: Mar. 25, 2025

(30) Foreign Application Priority Data
Mar. 29, 2024 (JP) 2024-057047

(51) Int. Cl. H04W 60/00; H04W 8/24; H04W 12/06; H04W 76/18

(52) U.S. Cl. CPC H04W 60/00; H04W 8/24; H04W 12/06; H04W 76/18

(57) ABSTRACT

A communication system includes a first terminal device, a second terminal device, a particular device, and a server. The server comprises a storage device and a controller having hardware. The controller receives, from the first terminal device, first user information and device identification information identifying the particular device. The controller registers the first user by storing registration information associating the first user information with the device identification information in the storage device. The controller also stores particular authentication information in association with the device identification information and transmits it to the particular device. After registering the first user, the controller receives the device identification information from the second terminal device and transmits a rejection notification. The controller then receives particular authentication information from the particular device in a logged-in state, obtains the first user information, and notifies a particular notification destination in response to the authentication information.

### REFERENCE TO RELATED APPLICATIONS

This application claims priority from Japanese Patent Application No. 2024-057047 filed on Mar. 29, 2024. The entire content of the priority application is incorporated herein by reference.

### BACKGROUND ART

The present disclosure relates to a communication system, and a server for the communication system.

An information processing system has been developed to provide a user registration form. In this system, an interface with multiple input fields is displayed on a terminal device, prompting the user to enter information in these fields.

### SUMMARY

In the aforementioned conventional technology, if one user is already registered with a device, it may not be generally possible for other users to register with the same device. Therefore, improvements are needed in handling such cases in user registration associated with devices.

According to aspects of the present disclosure, there is provided a communication system that includes a first terminal device, a second terminal device, a particular device, and a server. The first terminal device is used by a first user, while the second terminal device is used by a second user. The server is communicatively connected to the first terminal device, the second terminal device, and the particular device. The server includes a storage device and a controller having hardware configured to execute various functions.

The controller is configured to receive, from the first terminal device, first user information, which is information about the first user, and device identification information that identifies the particular device. Upon receiving the first user information and the device identification information, the controller registers the first user by storing registration information that associates the first user information with the device identification information in the storage device. When registering the first user, the controller also stores particular authentication information in association with the device identification information in the storage device. Additionally, the controller transmits the particular authentication information to the particular device when the first user is being registered.

After the registration of the first user, the controller receives the device identification information from the second terminal device. In response to receiving the device identification information from the second terminal device after the registration of the first user, the controller transmits a rejection notification to the second terminal device, indicating that registration of the second user using the second terminal device is rejected.

Furthermore, the controller receives particular authentication information from the particular device that is in a logged-in state. The logged-in state refers to a condition where an administrator is logged in to the particular device using administrator information that is not stored in the storage device of the server. Upon receiving the particular authentication information, the controller retrieves the first user information that is associated with the device identification information, where the device identification information is linked to the particular authentication information in the storage device. The controller then notifies the obtained first user information to a particular notification destination in response to receiving the particular authentication information.

According to the above configuration, the server stores particular authentication information in association with the device identification information when registering the first user and transmits the particular authentication information to the particular device. After the first user is registered, when the server receives the device identification information from the second terminal device and subsequently receives the particular authentication information from the particular device, the server retrieves the first user information associated with the particular authentication information and notifies a particular notification destination.

As a result, even when the registration of the second user is rejected due to an existing registration of the first user for the particular device, the first user information is notified to the particular notification destination. This enables the notification destination to take appropriate actions based on the registered first user information.

Furthermore, the notification of the first user information is conditioned on receiving the particular authentication information from the particular device that is in a logged-in state. The logged-in state refers to a condition where an administrator is logged in to the particular device using administrator information that is not stored in the storage device of the server. This ensures that the first user information is disclosed only under authorized conditions, thereby preventing unauthorized access and reducing potential security risks associated with user registration for the particular device.

According to aspects of the present disclosure, there is provided a communication system that includes a first terminal device, a second terminal device, a particular device, and a server. The first terminal device is used by a first user, and the second terminal device is used by a second user. The server includes a storage device and is configured to be communicatively connected to the first terminal device, the second terminal device, and the particular device. The server comprises a controller having hardware, which is configured to execute various operations.

The controller is configured to receive, from the first terminal device, first user information, which is information about the first user, and device identification information that identifies the particular device. Upon receiving the first user information and the device identification information, the controller registers the first user by storing registration information in the storage device, wherein the registration information associates the first user information with the device identification information. When registering the first user, the controller also stores particular identification information in association with the device identification information in the storage device. Additionally, the controller transmits the particular identification information to the particular device when the first user is being registered.

After the registration of the first user, the controller receives the device identification information from the second terminal device. In response to receiving the device identification information from the second terminal device after the registration of the first user, the controller transmits a rejection notification to the second terminal device, indicating that registration of the second user using the second terminal device is rejected.

Furthermore, the controller receives particular authentication information from the particular device that is in an administrator login state. The administrator login state refers to a condition where an administrator is logged in to the particular device using administrator information that is not stored in the storage device of the server. Upon receiving the particular authentication information, the controller identifies the registration information that includes the device identification information associated with the particular authentication information in the storage device. The controller then registers the second user by updating the identified registration information in the storage device to updated registration information, in which the second user information is associated with the device identification information.

According to the above configuration, the server stores particular identification information in association with the device identification information when registering the first user and transmits the particular identification information to the particular device. After the first user is registered, the server receives the device identification information from the second terminal device. In response to receiving the device identification information from the second terminal device after the registration of the first user, the server transmits a rejection notification to the second terminal device, indicating that registration of the second user is rejected. However, when the server subsequently receives the particular authentication information from the particular device that is in an administrator login state, the server identifies the registration information associated with the particular authentication information and registers the second user by updating the registration information to associate the second user information with the device identification information.

As a result, even when the first user is already registered for the particular device, the second user can still be registered by performing authentication in the administrator login state. This configuration ensures that user registration linked to the particular device is securely managed while preventing unauthorized modifications to registration information. Additionally, it reduces potential issues associated with user registration failures due to an existing registration.

According to aspects of the present disclosure, there is provided a server that includes a storage device and is configured to be communicatively connected to a first terminal device, a second terminal device, and a particular device. The first terminal device is used by a first user, and the second terminal device is used by a second user. The server further comprises a controller having hardware, which is configured to execute various operations.

The controller is configured to receive, from the first terminal device, first user information, which is information about the first user, and device identification information that identifies the particular device. Upon receiving the first user information and the device identification information, the controller registers the first user by storing registration information in the storage device, wherein the registration information associates the first user information with the device identification information. When registering the first user, the controller also stores particular identification information in association with the device identification information in the storage device. Additionally, the controller transmits the particular identification information to the particular device when the first user is being registered.

After the registration of the first user, the controller receives the device identification information from the second terminal device. In response to receiving the device identification information from the second terminal device after the registration of the first user, the controller transmits a rejection notification to the second terminal device, indicating that registration of the second user using the second terminal device is rejected.

Furthermore, the controller receives particular authentication information from the particular device that is in a login state. The login state refers to a condition where an administrator is logged in to the particular device using administrator information that is not stored in the storage device of the server. Upon receiving the particular authentication information, the controller obtains the first user information that is associated with the device identification information, wherein the device identification information is linked to the particular authentication information in the storage device. The controller then notifies the obtained first user information to a particular notification destination in response to receiving the particular authentication information.

According to aspects of the present disclosure, there is provided a server that includes a storage device and is configured to be communicatively connected to a first terminal device, a second terminal device, and a particular device. The first terminal device is used by a first user, and the second terminal device is used by a second user. The server further comprises a controller having hardware, which is configured to execute various operations.

The controller is configured to receive, from the first terminal device, first user information, which is information about the first user, and device identification information that identifies the particular device. Upon receiving the first user information and the device identification information, the controller registers the first user by storing registration information in the storage device, wherein the registration information associates the first user information with the device identification information. When registering the first user, the controller also stores particular identification information in association with the device identification information in the storage device. Additionally, the controller transmits the particular identification information to the particular device when the first user is being registered.

After the registration of the first user, the controller receives the device identification information from the second terminal device. In response to receiving the device identification information from the second terminal device after the registration of the first user, the controller transmits a rejection notification to the second terminal device, indicating that registration of the second user using the second terminal device is rejected.

Furthermore, the controller receives particular authentication information from the particular device that is in an administrator login state. The administrator login state refers to a condition where an administrator is logged in to the particular device using administrator information that is not stored in the storage device of the server. Upon receiving the particular authentication information, the controller identifies the registration information that includes the device identification information associated with the particular authentication information in the storage device. The controller then registers the second user by updating the identified registration information in the storage device to updated registration information, in which the second user information is associated with the device identification information.

### BRIEF DESCRIPTION OF DRAWINGS

FIG. 1 is a block diagram showing a configuration of a communication system.

FIG. 2 schematically shows a structure of a management database.

FIG. 3 is a sequence diagram of a first registration process.

FIGS. 4A and 4B show example screens displayed in the first registration process.

FIGS. 5-7 show a sequence diagram of a subsequent registration process.

FIGS. 8A-8E show part of records of device tables DT and token tables TT.

FIGS. 9A and 9B show example screens displayed in the subsequent registration process.

FIG. 10 shows an example screen displayed in the subsequent registration process.

FIG. 11 shows a sequence diagram of the subsequent registration process.

FIG. 12 shows an example deregistration confirmation screen.

### DESCRIPTION

### First Embodiment

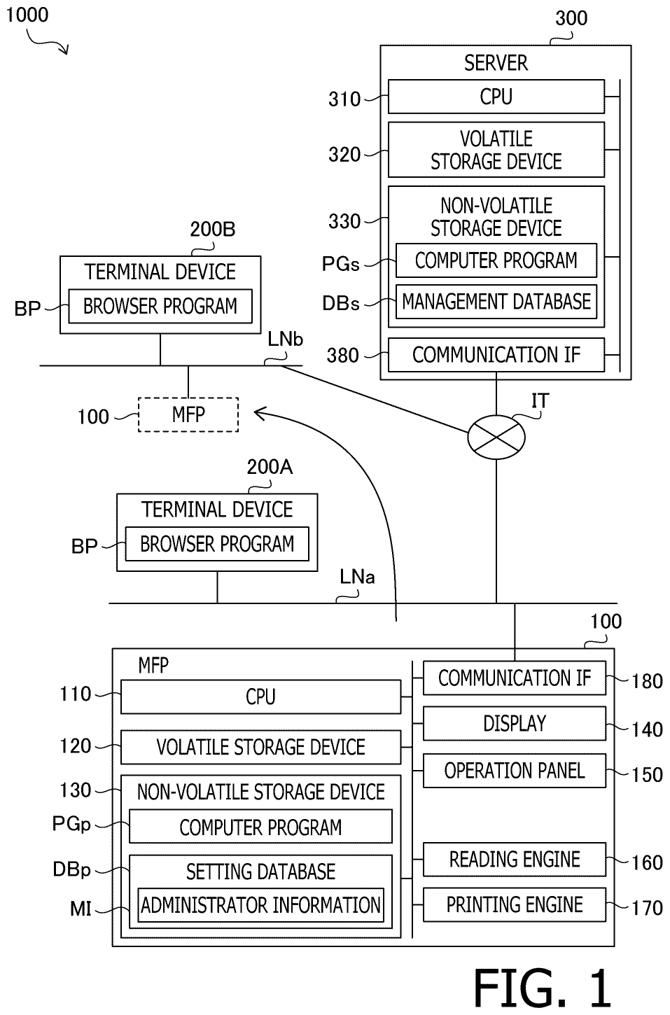

FIG. 1 is a block diagram showing a configuration of a communication system 1000 according to a first embodiment. The communication system 1000 includes an MFP (multi-function peripheral) 100, terminal devices 200A and 200B, and a server 300. The server 300 is for providing a particular service using the MFP 100 (hereinafter, the particular service will be referred to as a “service”).

The MFP 100 is a device configured to perform printing using ink as print agent. The MFP 100 includes a CPU 110, a volatile storage device 120 such as a DRAM, a non-volatile storage device 130 such as a hard disk drive or a flash memory, as a controller of the MFP 100. The MFP 100 also includes a display 140 such as an LCD to display images, an operation panel 150 provides with buttons and/or a touch panel to receive user operations, a reading engine 160, a printing engine 170, and a communication IF (interface) 180.

The communication interface 180 is an interface for connecting the MFP 100 to the Internet IT, such as a wired interface compliant with Ethernet (registered trademark of Xerox Corporation) or a wireless interface compliant with the Wi-Fi standard (a registered trademark of the Wi-Fi Alliance).

The CPU 110 is a processor configured to perform data processing. The volatile storage device 120 provides a buffer area configured to temporarily store intermediate data that is generated during processes performed by the CPU 110. The non-volatile storage device 130 is configured to store a computer program PGp to control the MFP 100, and a database DBp configured to store various information.

According to the present embodiment, the computer program PGp was initially stored in the non-volatile storage device 130 when the MFP 100 was manufactured and is retained therein. Alternatively, the computer program PGp may be provided, for example, in a form that can be downloaded from a server connected via the Internet IT, or in a form recorded on a storage medium such as a DVD-ROM, a USB memory stick, or the like.

The CPU 110 executes various processes for controlling the MFP 100 by executing the computer program PGp. For example, the MFP 100 (CPU 110) controls the printing engine 170 to print images. Additionally, the MFP executes the computer program PGp to communicate with the server 300 and perform processes related to services (e.g., a service registration processes, as described later).

The setting database DBp contains various setting information related to the MFP 100. The setting database DBp contains administrator information MI. The MFP 100 has a function of registering administrators. The administrator information MI is information (e.g., an administrator ID and password) required to log in to the MFP 100 as an administrator.

By inputting the administrator information MI into the MFP 100, the administrator can log in to the MFP 100. In a log-in state as an administrator, the administrator can perform operations on the MFP 100 that require administrator privileges (e.g., operations for modifying critical settings). The administrator can be set by the owner of the MFP 100. The registration of this administrator is managed solely by the MFP 100, independently of the server 300. For this reason, the administrator information MI is not stored in the server 300 but is stored exclusively in the MFP 100.

The reading engine 160 is configured to optically reading an image of an original document using, for example, a one-dimensional image sensor under the control of the CPU 110 to generate scan data that represents the image of the original document.

The printing engine 170 executes printing under the control of the CPU 110. In the present embodiment, the printing engine 170 is an inkjet-type printing engine configured to print images on a recording medium using multiple types of ink, such as cyan (C), magenta (M), yellow (Y), and black (K) ink. Alternatively, the printing engine 170 may be an electrophotographic printing engine that prints images on a recording medium using toner, housed in toner cartridges, as the color agent.

The MFP 100 is connected, for example, to the local network of a user and is used. In a state shown in FIG. 1, the MFP 100 is connected to a local area network LNa of User A and is used, for example, by User A.

Terminal devices 200A and 200B are computing devices (e.g., personal computers) owned by users of the service. Each of the terminal devices 200A and 200B includes a CPU, a memory, and a display (e.g., a liquid crystal display), which are well-known components and not shown in the drawings. In a modified configuration, the terminal devices 200A and 200B may also be a smartphone or a tablet computer. Each of the terminal devices 200A and 200B is equipped with a particular communication interface, which is not shown in the drawings, such as a wireless communication interface compliant with the Wi-Fi standard or a mobile communication standard (e.g., the LTE standard). Each of the terminal devices 200A and 200B has a browser program BP installed. By executing the browser program BP, each terminal device functions as a web browser. Acting as web browsers, each of the terminal devices 200A and 200B communicates with the server 300 and executes processes related to the service (e.g., the service registration process described later).

In this embodiment, the terminal device 200A is a terminal device used by User A and is connected to the local area network LNa (e.g., a local area network configured in User A's home).

In this embodiment, the terminal device 200B is a terminal device used by User B and is connected to a local area network LNb (e.g., a local area network configured in User B's home).

The server 300 is, for example, a computing device (e.g., a computer) operated by a service provider, such as a cloud server. The server 300 includes a CPU 310 functioning as a controller of the server 300, a volatile storage device 320 such as DRAM, a non-volatile storage device 330 such as a hard disk or flash memory, and a wired or wireless communication interface 380 for connecting to the Internet IT. The server 300 is connected to the Internet IT. This allows the server 300 to communicate with the MFP 100 and the terminal devices 200A and 200B, respectively, via the Internet IT.

The CPU 310 is a processing device (e.g., a processor) configured to perform data processing. The volatile storage device 320 provides a buffer area for temporarily storing various intermediate data generated during processing by the CPU 310. The non-volatile storage device 330 stores a computer program PGs and a management database DBs.

The computer program PGs is provided by the operator managing the server 300, for example, by uploading the computer program PGs to the server 300. By executing the computer program PGs, the CPU 310 of the server 300 provides the service. Furthermore, the server 300 operates in coordination with the MFP 100 and the terminal devices 200A and 200B to perform operations related to the service, such as a first registration process and a subsequent registration process, which will be described later.

The management database DBs contains various types of data necessary for executing processes related to the service, as described later.

In FIG. 1, only the MFP 100 is shown. However, the server 300 may be configured to communicate with multiple printers, including MFPs and/or standalone printers, to provide services that utilize the MFP 100. While the following description focuses on processes related to the MFP 100, these processes can also be performed with other printers included in the scope of the service.

The server 300 provides multiple types of services. For example, the services provided by the server 300 include various services utilizing the MFP 100, such as a print management service, a remote printing service, a storage service, and a content service.

The print management service manages information such as the remaining ink level of the MFP 100, as well as printing and failure history of the MFP 100. This service arranges ink replenishment based on the remaining ink level and performs maintenance for the MFP 100 based on its failure history or other relevant information. The remote printing service allows the MFP 100 to perform printing by generating print jobs using image files stored on the server 300 by a user or image files transmitted from a user's mobile terminal (not shown), and then transmitting the print jobs to the MFP 100. The storage service stores image files, such as scan data and print data generated using the MFP 100, on the server 300. The content service enables the use of content data, which represents content images, by downloading the content data to the MFP 100 for utilization with the MFP 100. The content images may include, for example, character fonts, characters from animations or comics, templates for greeting cards (e.g., New Year's cards or Christmas cards), and designs or patterns for calendars.

The following description assumes that the server 300 provides four types of services, labeled as services 1 to 4. In this embodiment, a user must complete user registration for each service the user wishes to use. During the registration process for each service, the user and a device (e.g., the MFP 100) are associated and registered together.

In this embodiment, a single device cannot be registered multiple times for the same service (e.g., service 1). For example, if User A has registered for services 1 and 2 with the MFP 100, User B cannot register for services 1 or 2 with the same MFP 100. However, User B can register for services 3 or 4 with the same MFP 100 if the User A has not registered for the services 3 or 4 with the MFP 100.

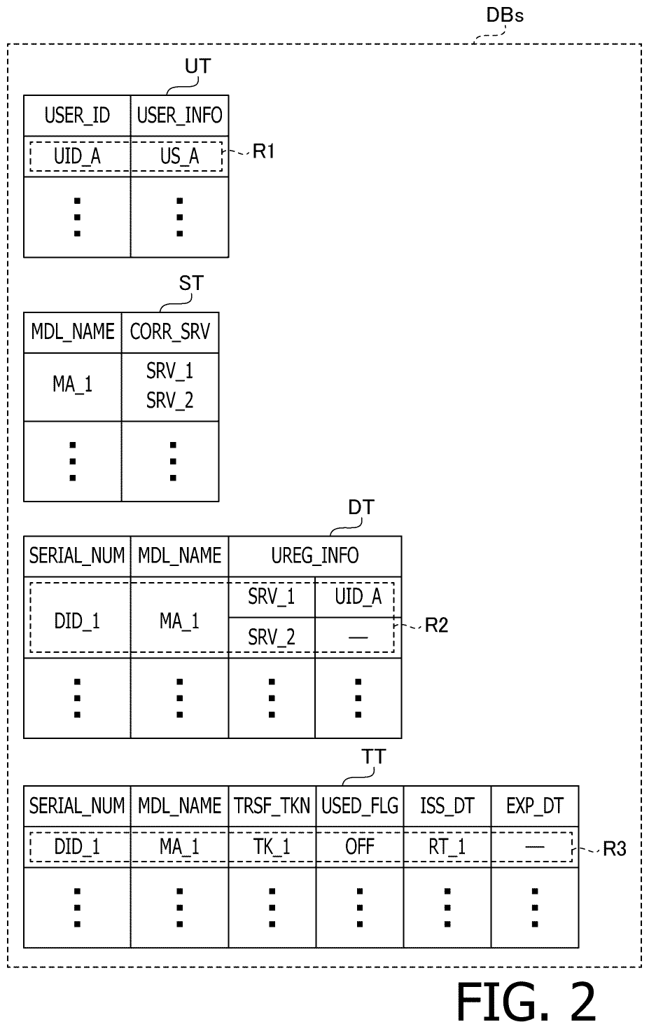

The management database DBs stored in the non-volatile storage device 330 of the server 300 will be described. FIG. 2 is an explanatory diagram of the management database DBs. As shown in FIG. 2, the management database DBs includes a user table UT, a corresponding service table ST, a device table DT, and a token table TT.

In the tables shown in FIG. 2, the terms “USER_ID,” “USER_INFO,” “MDL_NAME,” “CORR_SRV,” “SERIAL_NUM,” “SRV_1,” “SRV_2,” “UREG_INFO,” “TRSF_TKN,” “USED_FLG,” “ISS_DT,” and “EXP_DT” are used as abbreviations for user ID, user information, model name, corresponding services, serial number, service 1, service 2, user registration information, transfer token, used flag, issue date, and expiration date, respectively.

The user table UT is a table which contains information about users of the service. In this embodiment, the user table UT contains user IDs that identify multiple users of the service. Additionally, the user table UT contains various types of information (user information) associated with each user ID. The user information may include, for example, personal information necessary for using the service, such as the user's name, address, email address, and payment information (e.g., credit card numbers), which are not shown in the drawings. In the example shown in FIG. 2, user information “US_A” is recorded in association with the user ID “UID_A” of User A.

The corresponding service table ST is a table in which the services available for use with devices of each model (hereinafter also referred to as “corresponding services”) are recorded. For example, in the example shown in FIG. 2, services 1 and 2 are recorded in association with the model name “MA_1”. This means that the corresponding services for a device with the model name “MA_1” are services 1 and 2 among services 1 to 4.

The device table DT is a table which contains information about devices (e.g., the MFP 100) managed by the server 300. In this embodiment, the device table DT contains serial numbers as identification information for multiple devices managed by the server 300. Additionally, the device table DT contains a model name and user registration information in association with each serial number. The user registration information indicates whether a user has registered for services available for use with the device. If a user is registered, the user registration information further specifies the registered user. Specifically, for each service available for use with the device, the user registration information includes the user ID of the registered user if the user is registered. If the user is not registered, no user ID is associated with the service.

In the device table DT shown in FIG. 2, the serial number “DID_1” of the MFP 100 is associated with the model name “MA_1” of the MFP 100, along with the user registration information for services 1 and 2, which are available for use with the MFP 100. For service 1, the user ID “UID_A” of User A is recorded, indicating that User A is registered as a user of service 1 using the MFP 100. For service 2, no user ID is recorded, indicating that no user registration has been completed for service 2 using the MFP 100.

The token table TT is a table which contains token information related to transfer tokens for each device. For example, the token table TT shown in FIG. 2 contains token information in association with the serial number and model name of each device. The token information includes a transfer token, a used flag, an issue date, and an expiration date.

The transfer token is authentication information used in a registration process described later and is associated with a device (e.g., the MFP 100). The transfer token is, for example, a string composed of a particular number of characters generated randomly.

The used flag is a flag that indicates whether the associated transfer token has been used. When the used flag is OFF, the transfer token is unused and remains valid as long as the expiration date has not passed (i.e., the transfer token being valid on or before the expiration date). When the used flag is ON, the transfer token is already used and becomes invalid regardless of the expiration date.

The issue date is the date and time when the transfer token was issued, or in other words, the date and time when the transfer token was generated and recorded in the token table TT. The expiration date is set, for example, to a date and time that is a particular period (e.g., several minutes to several days) after the transfer token is generated and recorded in the token table TT.

The management database DBs contains various information necessary for providing services 1 to 4. For example, the management database DBs includes tables for managing the remaining ink levels of devices (e.g., printers and/or MFPs) used for printing services. However, since such information is less relevant to the present disclosure, the illustration and description thereof are omitted.

Next, the user registration processes for the aforementioned services 1 to 4 will be described. For each of services 1 to 4, user registration is performed in association with a device (e.g., the MFP 100). The user registration process for a single device includes an first registration process and a subsequent registration process. The first registration process is executed when user registration has not yet been performed for a specific service (e.g., service 1) and a user registers for that specific service for the first time. The subsequent registration process is executed when the user registration has already been performed for a specific service (e.g., service 1) and a different user attempts to register for that specific service.

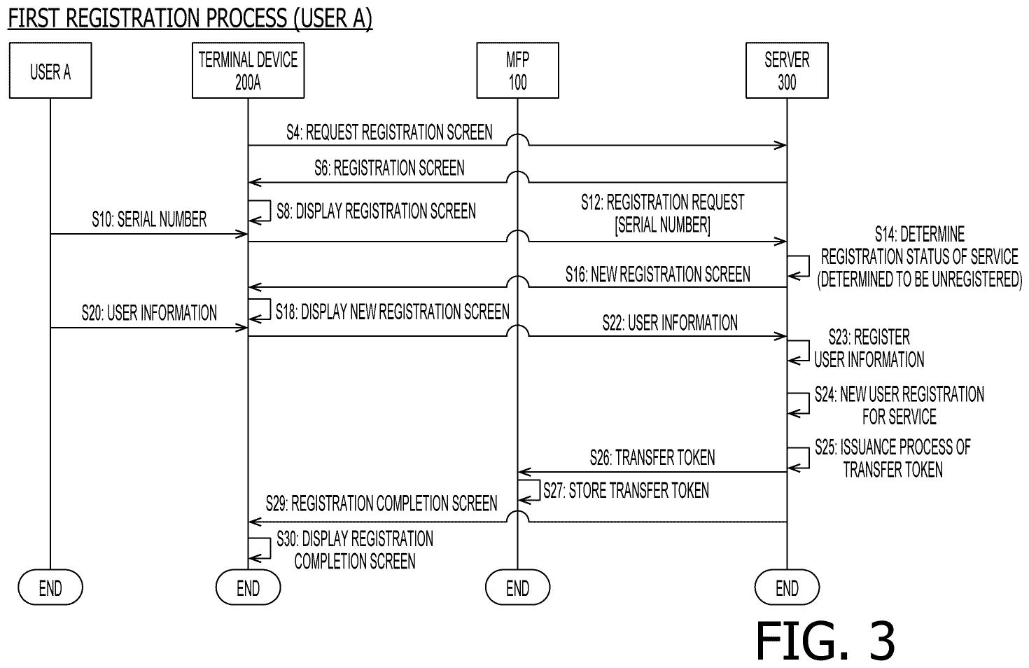

FIG. 3 is a sequence diagram of the first registration process. The example in FIG. 3 illustrates the first registration process executed when User A performs user registration for service 1 in association with the MFP 100. This first registration process shown in FIG. 3 is executed under the condition that the terminal device 200A and the MFP 100 are connected to User A's local area network LNa, and both the terminal device 200A and the MFP 100 are powered on.

In S4, the terminal device 200A transmits a registration screen request to the server 300 to request the data for the registration screen. Communication between the terminal devices 200A and 200B and the server 300 is performed according to a known protocol, such as HTTP (Hypertext Transfer Protocol). For example, User A launches the browser program BP on the terminal device 200A, causing the terminal device 200A to function as a web browser, and performs a particular operation. The particular operation includes, for instance, entering a Uniform Resource Locator (URL) of the server 300 to access a web page provided by the server 300 and entering instructions for user registration for service 1 via the web page. Upon receiving such operations, the terminal device 200A transmits the registration screen request to the server 300.

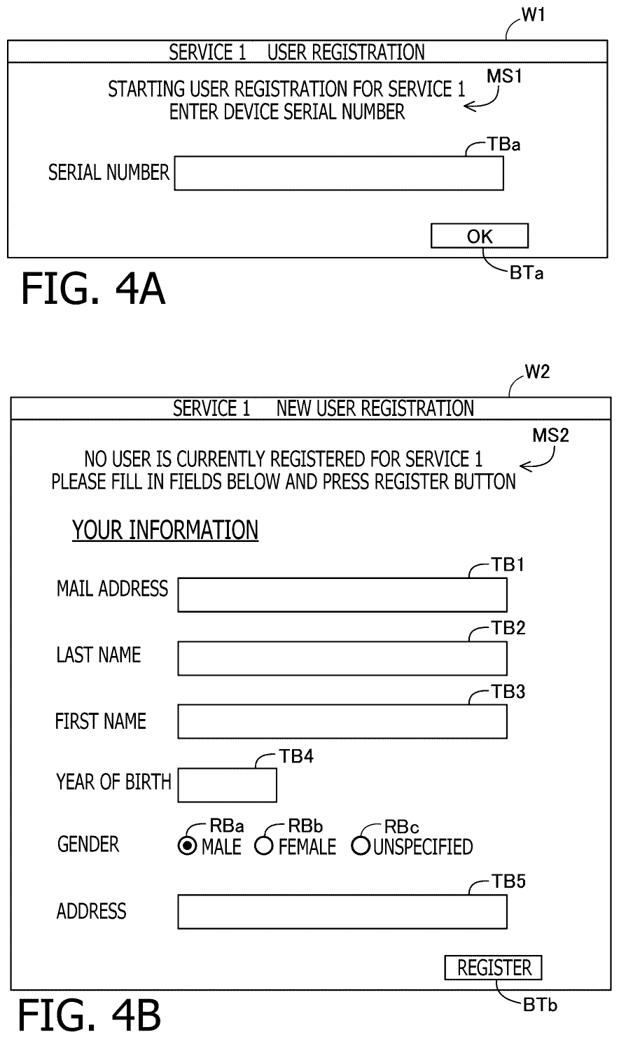

When the server 300 (CPU 310) receives the registration screen request, the server 300 transmits the data for a registration screen W1 (see FIG. 4A) for service 1 to the terminal device 200A in S6. Upon receiving the data for the registration screen W1, the terminal device 200A uses the data for the registration screen W1 to display the registration screen W1 on the display of the terminal device 200A in S8.

FIGS. 4A and 4B illustrate examples of screens displayed during the first registration process. The registration screen W1 shown in FIG. 4A includes a message MS1 prompting the user to input the serial number of the device for user registration of service 1, an input field TBa for entering the serial number, and an OK button BTa.

In S10, the terminal device 200A obtains a serial number from User A via the registration screen W1. Concretely, when User A inputs the serial number of the MFP 100 into an input field TBa and presses the OK button BTa, the terminal device 200A retrieves the serial number entered in the input field TBa.

In S12, the terminal device 200A transmits the serial number obtained in S10 to the server 300. In this embodiment, transmission of the serial number of the MFP 100 serves as a registration request.

When the server 300 receives the serial number of the MFP 100 from the terminal device 200A, the server 300 determines the registration status of service 1, which is the target of user registration, in S14. Concretely, the server 300 determines whether user registration for service 1 has been performed in association with the MFP 100. To make this determination, the server 300 searches the device table DT for the serial number received in S14. If the serial number is recorded in the device table DT, the server 300 checks whether a user ID for service 1 is associated with the serial number. If a user ID for service 1 is associated with the serial number, the server 300 determines that user registration for service 1 has already been performed in association with the MFP 100. If the serial number is not recorded in the device table DT, the server 300 determines that user registration for service 1 has not been performed in association with the MFP 100. Similarly, if no user ID for service 1 is associated with the serial number, even though the serial number is recorded in the device table DT, the server 300 also determines that user registration for service 1 has not been performed (unregistered) in association with the MFP 100.

In the first registration process, since a record containing the serial number of the MFP 100 is not recorded in the device table DT, the server 300 determines in S14 that user registration for service 1 has not been performed in association with the MFP 100. In this case, the server 300 transmits the data for a new registration screen W2 (see FIG. 4B) to the terminal device 200A in S16. Upon receiving the data for the new registration screen W2, the terminal device 200A uses the data to display the new registration screen W2 on its display in S18.

The new registration screen W2 shown in FIG. 4B notifies the user that user registration for service 1 has not been performed and prompts the user to proceed with a new registration. The screen includes a message MS2, input elements for entering various user information required for registration (i.e., input fields TB1 to TB5 and radio buttons RBa, RBb, and RBc), and a registration button (“REGISTER”) BTb.

In S20, the terminal device 200A obtains user information from User A via the new registration screen W2. Concretely, when User A enters the user information into the input elements of the new registration screen W2 (input fields TB1 to TB5 and radio buttons RBa, RBb, and RBc) and presses the register button BTb, the terminal device 200A retrieves the user information entered in each input element. In the example shown in FIG. 4B, the retrieved user information includes an email address, a name, a birth year, a gender, and an address.

In S22, the terminal device 200A transmits the user information obtained from User A to the server 300.

When the server 300 receives the user information, the server 300 registers the obtained user information (information of User A) in S23. Concretely, the server 300 generates a user ID for User A. The server 300 records the received user information in the user table UT in association with the generated user ID. As a result, as shown by broken lines in FIG. 2, a record RI containing the user ID “UID_A” of User A and the information “US_A” of User A is stored in the user table UT.

In S24, the server 300 performs a new user registration for the service. That is, User A is newly registered as a user associated with the MFP 100 for service 1. Concretely, the server 300 identifies the model name of the MFP 100 by searching for the serial number received in S12 in a table (not shown) that associates serial numbers with model information, such as model names. The server 300 then refers to the corresponding service table ST (see FIG. 2) to determine the services available for use with the device that has the identified model name. The server 300 registers User A as a user of service 1 by recording user registration information in the device table DT. This user registration information associates the serial number and model name of the MFP 100 with service 1 and the user ID of User A. As a result, as shown by broken lines in FIG. 2, a record R2 is stored in the device table DT. The record R2 includes the serial number “DID_1” of the MFP 100, the model name “MA_1” of the MFP 100, and the user registration information associating service 1 with the user ID “UID_A” of User A. In the example record R2 shown in FIG. 2, no user ID is registered for service 2, indicating that user registration for service 2 has not been performed in association with the MFP 100 (FIG. 2).

In S25, the server 300 executes an issuance process for the transfer token. Concretely, the server 300 generates a transfer token. The server 300 stores the generated transfer token in the token table TT in association with the serial number and model name of the MFP 100. As a result, as shown by broken lines in FIG. 2, a record R3 is stored in the token table TT. The record R3 includes the serial number “DID_1”, the model name “MA_1”, and the transfer token “TK_1”. At this point, as shown in FIG. 2, the used flag in the record R3 is set to “OFF”, the issue date is set to the current date and time “RT_1”, and the expiration date is not yet set.

In S26, the server 300 transmits the generated transfer token to the MFP 100. In the present embodiment, the MFP 100 establishes a continuous connection with the server 300 while powered on. The continuous connection is established, for example, according to XMPP (extensible Messaging and Presence Protocol). Communication between the MFP 100 and the server 300 is performed using this continuous connection.

When the MFP 100 receives the transfer token from the server 300, the MFP 100 stores the transfer token in the setting database DBp in S27.

In S29, the server 300 transmits the data for a registration completion screen to the terminal device 200A. Upon receiving the data for the registration completion screen, the terminal device 200A uses the received data to display the registration completion screen on the display thereof in S30. Although not shown in the drawings, the registration completion screen includes a message indicating that user registration for service 1, associated with the MFP 100, has been successfully completed.

Once the first registration process is completed, User A can use service 1 with the MFP 100. For example, if service 1 is the aforementioned print management service, the MFP 100 receives setting information for a periodic transmission from the server 300 and stores the setting information in the setting database DBp. Subsequently, the MFP 100 periodically uploads information such as remaining ink levels, print history, and failure history to the server 300 in accordance with the periodic transmission setting information. Based on such information uploaded from the MFP 100, the server 300 performs tasks such as arranging ink replenishment and executing billing processes.

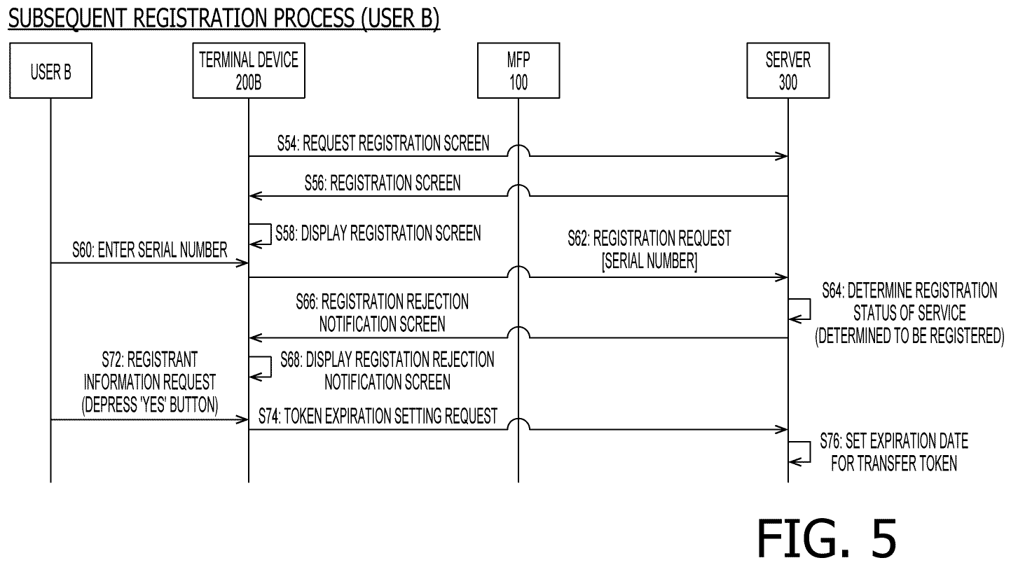

FIGS. 5 to 7 are sequence diagrams of the subsequent registration process. The subsequent registration process is executed when user registration for a specific service (e.g., service 1) has already been completed, and a different user registers for the same service.

In the example shown in FIGS. 5 to 7, User B performs user registration for service 1 while User A is already registered for service 1 in association with the MFP 100 through the first registration process shown in FIG. 3. This example assumes a scenario where User A, who is registered for service 1, has transferred ownership of the MFP 100 to User B. At the start of the subsequent registration process shown in FIG. 5, the MFP 100 is connected to User B's local area network LNb, as indicated by broken lines in FIG. 1, instead of being connected to the local area network LNa as indicated by solid lines in FIG. 1. The subsequent registration process is executed when the terminal device 200B and the MFP 100 are connected to the local area network LNb and both the terminal device 200B and the MFP 100 are powered on.

Another scenario in which the subsequent registration process is executed occurs when User A and User B are cohabiting family members, both connected to the same local area network LNa. For example, after User A completes the user registration, User B may attempt to perform user registration without realizing that User A has already registered. In this case, because both users A and B share the same local area network LNa, the subsequent registration process is executed with the MFP 100 and the terminal device 200B connected to the local area network LNa. This scenario differs from the example shown in FIG. 1.

In S54, the terminal device 200B transmits a registration screen request to the server 300 to request the data for the registration screen, similar to S4 in FIG. 3. When the server 300 receives the registration screen request, the server 300 transmits the data for the registration screen W1 for service 1 to the terminal device 200B in S56, similar to S6 in FIG. 3. Upon receiving the data for the registration screen W1, the terminal device 200B uses the data to display the registration screen W1 (FIG. 4A) on its display in S58, similar to S8 in FIG. 3.

In S60, the terminal device 200B obtains a serial number from User B via the registration screen W1, similar to S10 in FIG. 3. In S62, the terminal device 200B transmits the serial number obtained in S60 to the server 300, similar to S12 in FIG. 3. Similarly to S12, transmission of the serial number of the MFP 100 serves as the registration request.

When the server 300 receives the serial number of the MFP 100, the server 300 determines the registration status of service 1, which is the target of user registration, in S64, similar to S14 in FIG. 3.

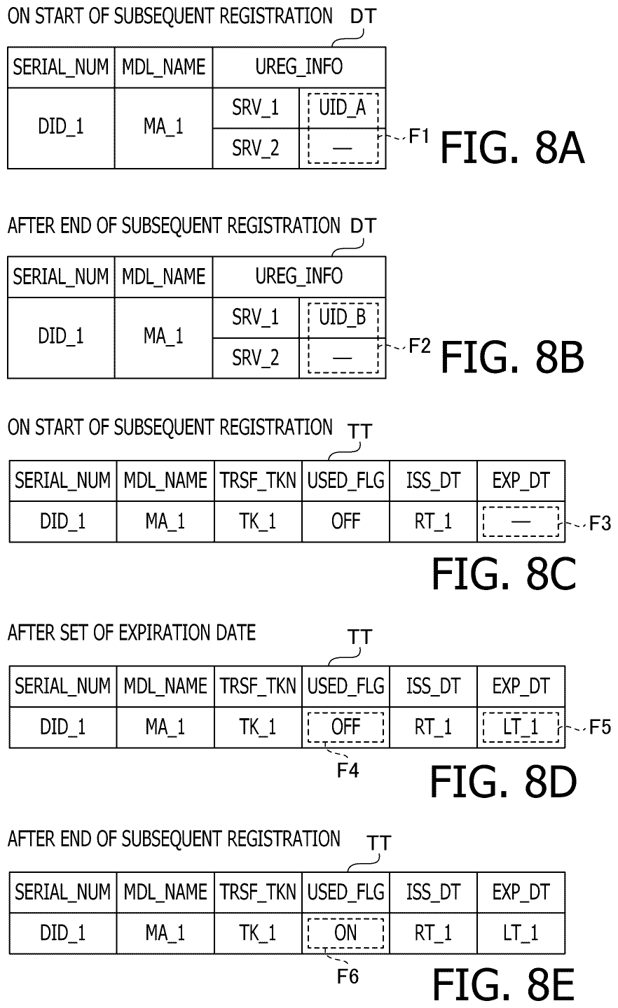

FIGS. 8A-8E illustrate a partial example of records in the device table DT and the token table TT. In the tables shown in FIG. 8, similar to FIG. 2, the terms “USER_ID,” “USER_INFO,” “MDL_NAME,” “CORR_SRV,” “SERIAL_NUM,” “SRV_1,” “SRV_2,” “UREG_INFO,” “TRSF_TKN,” “USED_FLG,” “ISS_DT,” and “EXP_DT” are used as abbreviations for user ID, user information, model name, corresponding services, serial number, service 1, service 2, user registration information, transfer token, used flag, issue date, and expiration date, respectively.

At the start of the subsequent registration process, the device table DT contains the record shown in FIG. 8A. This record was registered during the first registration process described in FIG. 3. When the server 300 searches the device table DT for the serial number, which is transmitted by the terminal device 200B in S60, the server 300 retrieves the record shown in FIG. 8A. In this record, as indicated by a broken-line frame F1, the ID “UID_A” of User A is associated as the user ID for service 1. Therefore, in S64, unlike S14 in FIG. 3, the server 300 determines that user registration for service 1 has already been completed in association with the MFP 100.

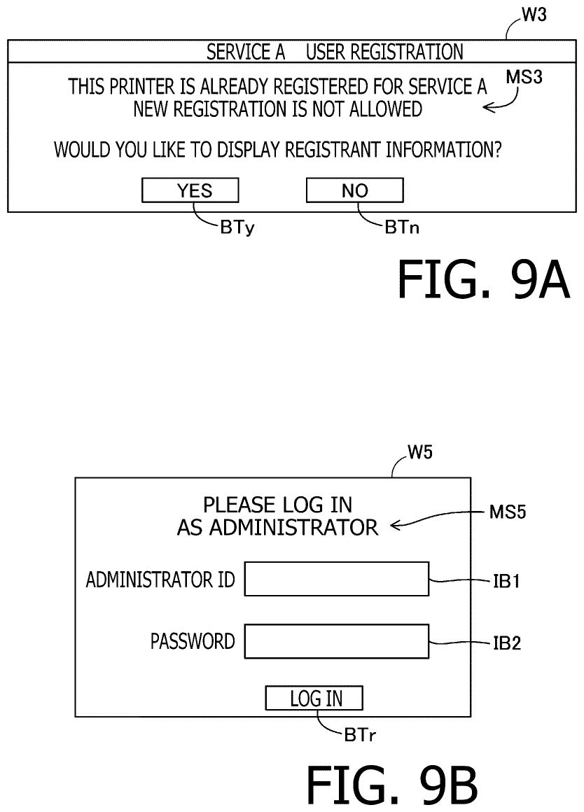

In this case, the server 300 transmits the data for a registration rejection notification screen W3 (see FIG. 9A) to the terminal device 200B in S66, indicating that the registration of User B is rejected. Upon receiving the data for the registration rejection notification screen W3, the terminal device 200B uses the data to display the registration rejection notification screen W3 on the display in S68.

FIGS. 9A and 9B illustrate an example of screens displayed during the subsequent registration process. The registration rejection notification screen W3 shown in FIG. 9A notifies User B that registration is rejected because a user is already registered for service 1. The screen also includes a message MS3 asking whether to display information about the registered user, a YES button BTy, and a NO button BTn. By viewing the registration rejection notification screen W3, User B recognizes that user registration for service 1 associated with the MFP 100 has already been completed by another user, and therefore, User B cannot complete registration. If User B decides to abandon the registration attempt for service 1, User B presses the NO button BTn. However, it is typically expected that User B will press the YES button BTy. If the NO button BTn is pressed, the terminal device 200B terminates the display of the registration rejection notification screen W3 and terminates the subsequent registration process.

By pressing the YES button BTy, User B can request information about the registered user. In S72 of FIG. 5, the terminal device 200B obtains the registration information request entered by User B. After obtaining the registration information request, the terminal device 200B transmits a token expiration setting request to the server 300 in S74.

When the server 300 receives the token expiration setting request, the server 300 sets the expiration date for the transfer token in S76. FIG. 8C shows a record in the token table TT at the start of the subsequent registration process, which includes the serial number “DID_1” of the MFP 100. As indicated by a broken-line frame F3 in FIG. 8C, at this point, the record in the token table TT containing the serial number “DID_1” does not have an expiration date recorded. The server 300 sets the expiration date for the transfer token by recording the expiration date in this record.

As described above, the expiration date is set to a date and time that is a particular period (e.g., several minutes to several days) after the current date and time when the expiration date is about to be set. FIG. 8D shows the record in the token table TT after the expiration date has been set. As indicated by a broken-line frame F5 in FIG. 8D, the record in the token table TT containing the serial number “DID_1” now includes the expiration date “LT_1” for the transfer token. As this description illustrates, in this embodiment, the transfer token is assigned an expiration date calculated based on the point in time when S76 is executed.

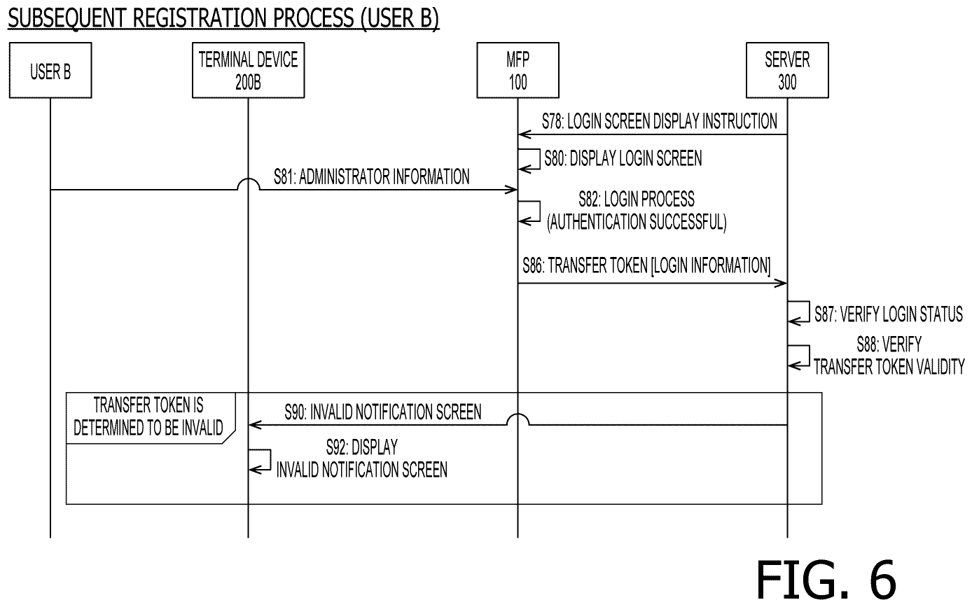

In S78 of FIG. 6, the server 300 transmits a login screen display instruction to the MFP 100. Upon receiving the login screen display instruction, the MFP 100 displays a login screen W5 (see FIG. 9B) on the display 140 in S80. The login screen W5 is a screen used by the administrator of the MFP 100 to log in to the MFP 100. The data for the login screen W5 is pre-stored in the non-volatile storage device 130 of the MFP 100. As described above, the MFP 100 includes a function for registering an administrator. The administrator can log in to the MFP 100 by entering administrator information, such as an administrator ID and a password, into the MFP 100. Here, it is assumed that User B has been registered as the administrator of the MFP 100 and is aware of the administrator information, including the administrator ID and password.

The login screen W5 shown in FIG. 9B includes a message MS5 prompting the administrator to log in, input fields IB1 and IB2 for entering administrator information (in the example of FIG. 9B, the administrator ID and password), and a login button BTr.

In S81, the MFP 100 obtains administrator information from User B via the login screen W5. Concretely, when User B enters the administrator information required to log in as an administrator into the input fields IB1 and IB2 and presses the login button BTr, the MFP 100 obtains the administrator ID and password entered in the respective input fields as the administrator information.

In S82, the MFP 100 executes a login process using the obtained administrator information. Concretely, the MFP 100 determines whether the obtained administrator information matches the administrator information MI contained in the setting database DBp (FIG. 1). If the obtained administrator information matches the administrator information MI contained in the setting database DBp, the MFP 100 determines that authentication for login has succeeded and enters a logged-in state, where operations requiring administrator privileges are accepted. If the obtained administrator information does not match the stored administrator information MI, the MFP 100 determines that authentication has failed and does not enter the logged-in state. In the case of authentication failure, the MFP 100 displays a message on the display 140 indicating the authentication failure, and the subsequent registration process is interrupted (not shown in the drawings). Here, it is assumed that authentication is successful and the MFP 100 enters the logged-in state.

When the MFP 100 enters the logged-in state, the MFP 100 transmits the transfer token contained in the setting database DBp to the server 300 in S86. As explained above, the MFP 100 is controlled such that the transfer token is transmitted to the server 300 only when the MFP 100 is in the logged-in state. If the MFP 100 is not in the logged-in state, the transfer token is not transmitted. It should be noted that the transfer token is transmitted along with login information that indicates whether the MFP 100 is in the logged-in state.

When the server 300 receives the transfer token and login information, the server 300 checks the logged-in state of the MFP 100 based on the login information in S87. If the login information indicates that the MFP 100 is not in the logged-in state, the server 300, for example, transmits an error notification to the MFP 100, and the subsequent registration process is interrupted (not shown in the figures). Here, it is assumed that the login information indicates that the MFP 100 is in the logged-in state. If the login information confirms that the MFP 100 is in the logged-in state, the server 300 proceeds to S88.

This configuration enhances security and reliability by ensuring that the server 300 verifies the transfer token was transmitted from the MFP 100 only while in the logged-in state. Even if there is an issue with the internal control of the MFP 100, the server 300 can independently confirm the validity of the transfer token based on the accompanying login information. This dual-layer verification mechanism minimizes the risk of unauthorized token transmission and ensures robust authentication throughout the process.

In S88, the server 300 verifies the validity of the transfer token. Concretely, the server 300 searches the token table TT for a record containing the serial number “DID_1”, associated with the MFP 100. Through this search, the record shown in FIG. 8D is retrieved. The server 300 determines whether the transfer token “TK_1”, included in the record shown in FIG. 8D, matches the transfer token received in S86. If the transfer token “TK_1”, in the record, matches the transfer token received in S86, the server 300 checks whether the used flag, included in the record in FIG. 8D, is set to “OFF”. If the used flag in the record in FIG. 8D is “OFF” (see the broken-line frame F4), the server 300 further checks whether the current date and time fall within the expiration date “LT_1”, included in the record in FIG. 8D. If the current date and time are within the expiration date “LT_1” (see the broken-line frame F5), the server 300 determines that the transfer token received from the MFP 100 is valid.

The server 300 determines that the transfer token received from the MFP 100 is invalid if any of the following conditions are met: the transfer token “TK_1”, included in the record shown in FIG. 8D, does not match the received transfer token; the used flag included in the record shown in FIG. 8D is set to “ON”; or the current date and time have passed the expiration date “LT_1”, included in the record shown in FIG. 8D.

If the transfer token received from the MFP 100 is determined to be invalid, S90 and S92 in FIG. 6 are executed. In S90, the server 300 transmits the data for an invalid notification screen to the terminal device 200B. Upon receiving the data for the invalid notification screen, the terminal device 200B uses the received data to display the invalid notification screen on its display in S92. Although not shown in the drawings, the invalid notification screen includes a message indicating that the transfer token is invalid and, therefore, user registration or notification of information about the registered user cannot be completed. In this case, the subsequent registration process is interrupted.

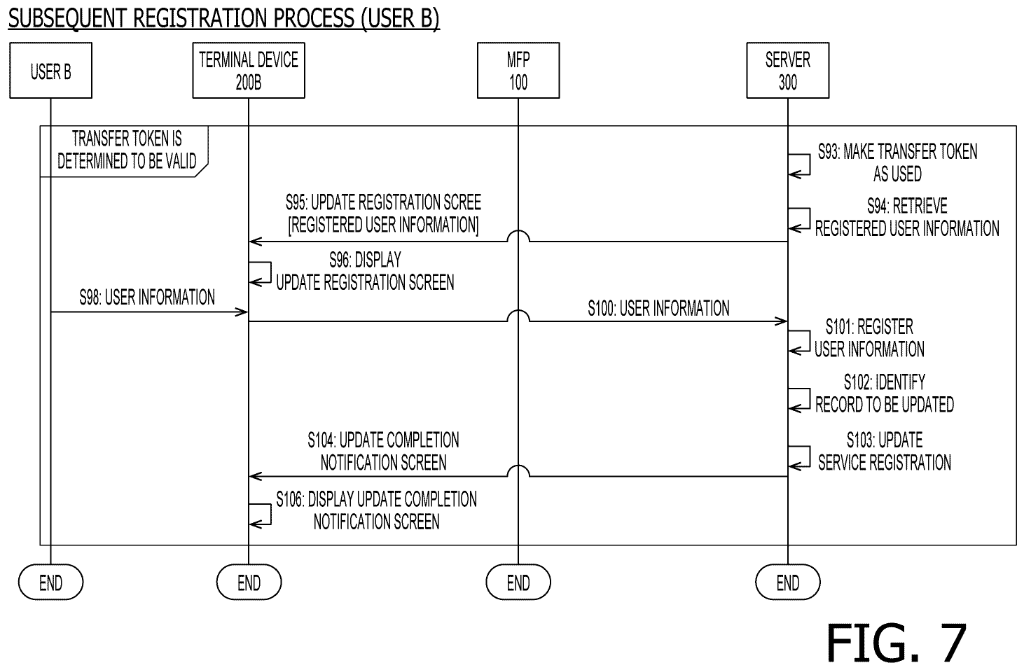

If the transfer token received from the MFP 100 is determined to be valid, S93 to S106 in FIG. 7 are executed. In S93, the server 300 updates the status of the transfer token to “used”. At this point, as indicated by the broken-line frame F4 in FIG. 8D, the used flag in the record of the token table TT that includes the serial number “DID_1” of the MFP 100 is set to “OFF”. The server 300 changes this used flag from “OFF” to “ON”, as shown by a broken-line frame F6 in FIG. 8E. As a result, the transfer token becomes invalid, even if it is still within its expiration period.

In S94, the server 300 obtains information about the registered user. Concretely, the server 300 refers to the user registration information in the record of the device table DT containing the serial number “DID_1” (FIG. 8A) to obtain the user ID “UID_A” registered for service 1. The server 300 then searches the user table UT (FIG. 2) for the record containing the user ID “UID_A” and retrieves the necessary information from the user information “US_A” included in the record. In this embodiment, the server 300 retrieves the name of User A, which is included in the user information “US_A”.

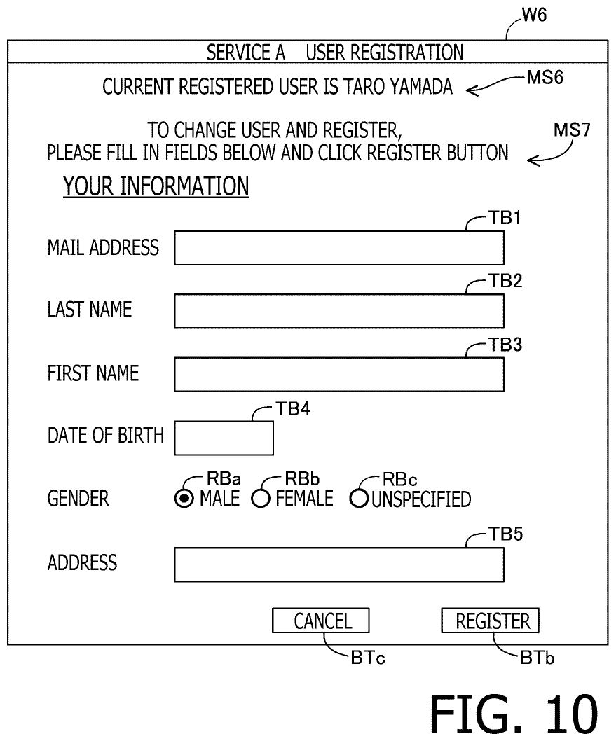

In S95, the server 300 transmits the data for an update registration screen W6 (see FIG. 10) to the terminal device 200B. As described later, the update registration screen W6 includes information about the registered user, which in this embodiment is the name of User A. Upon receiving the data for the update registration screen W6, the terminal device 200B uses the data to display the update registration screen W6 on its display in S96.

FIG. 10 illustrates the example of the update registration screen W6. The update registration screen W6 includes a message MS6 that notifies the registered user's information, which in this example (FIG. 10) is the name of User A. This allows User B to obtain information about the registered user, User A. Consequently, User B can take appropriate actions, such as contacting User A to obtain consent for changing the registered user to User B.

The update registration screen W6 also includes a message MS7 notifying that the user can be changed and registered, input elements (input fields TB1 to TB5 and radio buttons RBa, RBb and RBc) for entering user information, similar to the new registration screen W2 in FIG. 4B, a register button BTb, and a cancel button BTc.

If User B chooses to maintain the current user registration without making changes, User B presses the cancel button BTc. When the cancel button BTc is pressed, the terminal device 200B terminates the display of the update registration screen W6, and the subsequent registration process is interrupted (not shown in the drawings). Here, it is assumed that User B enters user information into the input elements (input fields TB1 to TB5 and radio buttons RBa, RBb, and RBc) on the update registration screen W6 and then presses the register button BTb.

When the register button BTb is pressed, the terminal device 200B obtains the user information entered into each input element in S98. In S100, the terminal device 200B transmits the obtained user information to the server 300.

When receiving the user information, the server 300 registers the obtained user information (information about User B) in S101. Concretely, the server 300 generates a user ID for User B. The server 300 records the received user information in the user table UT, associating the same with the generated user ID.

In S102, the server 300 identifies the record to be updated. That is, the server 300 identifies the record in the device table DT that contains the serial number associated with the transfer token (in this embodiment, the serial number “DID_1” of the MFP 100), as shown in FIG. 8A.

In S103, the server 300 updates the registration for service 1. Specifically, the user registered for service 1, which is associated with the MFP 100, is changed from User A to User B. More concretely, the server 300 updates the user registration information included in the identified record shown in FIG. 8A. In this record, as indicated by the broken-line frame F1 in FIG. 8A, the user ID “UID_A”, which corresponds to User A, is recorded as the user ID for service 1. The server 300 modifies this record so that, as indicated by the broken-line frame F2 in FIG. 8B, the user ID for service 1 is changed from “UID_A”, corresponding to User A, to “UID_B”, corresponding to User B. As a result, for service 1, the serial number “DID_1” of the MFP 100 is associated with the user ID “UID_B”, corresponding to User B, and User B is registered as the user of service 1. The registration associating User A with service 1 is thereby canceled.

In S104, the server 300 transmits the data for an update completion notification screen to the terminal device 200B. Upon receiving the data for the update completion notification screen, the terminal device 200B uses the data to display the update completion notification screen on its display in S106. Although not shown in the drawings, the update completion notification screen includes a message indicating that the user registered for service 1, associated with the MFP 100, has been updated. Once this subsequent registration process is completed, User B can use service 1 with the MFP 100.

According to the embodiment described above, in the first registration process shown in FIG. 3, the server 300 receives the serial number of the MFP 100 (S12), and then, user information for User A (S22) from User A via the terminal device 200A. Then, the server 300 registers User A by storing registration information, which associates the user information for User A with the serial number, in the management database DBs (the user table UT and device table DT shown in FIG. 2) (S24 in FIG. 3). When registering User A, the server 300 stores the transfer token in the management database DBs, associating the transfer token with the serial number of the MFP 100 (FIG. 2 and S25 in FIG. 3). Additionally, the server 300 transmits the transfer token to the MFP 100 during the registration process for User A (S26 in FIG. 3).

In the subsequent registration process following the first registration process (FIGS. 5-7), the server 300 receives the serial number of the MFP 100 from User B via the terminal device 200B (S62 in FIG. 5). At this point, since the server 300 determines that the user registration for service 1 has already been completed in association with the MFP 100 (S64), the server 300 transmits the registration rejection notification screen W3 to the terminal device 200B, indicating that the registration of User B for service 1 in association with the MFP 100 has been rejected (S66 in FIG. 5).

After transmitting the registration rejection notification screen W3, the server 300 receives the transfer token from the MFP 100, which is in the logged-in state (S86 in FIG. 6). When the transfer token is received, the server 300 retrieves information about User A (e.g., the name of User A) from the management database DBs (device table DT and token table TT), based on the serial number associated with the transfer token (S94 in FIG. 7). The server 300 then notifies the terminal device 200B of the retrieved information about User A (e.g., the name of User A) (S95 in FIG. 7). As a result, even in cases where User A is already registered for service 1 in association with the MFP 100 and User B cannot register due to the conflict, information about User A, who is the registered user, is notified to User B. Consequently, User B can take appropriate action based on the information about User A. For example, as described above, User B can contact User A to obtain consent to change the registered user to themselves. It is also possible that a family member living with User B has already registered for the service. In such cases, the update registration screen W6 displays the name of the family member. This allows User B to recognize that the registered user is a family member. In this scenario, User B may choose to keep the family member's registration as is and use service 1 together with the family member.

Furthermore, the notification of User A's information is conditioned on the receipt of the transfer token from the MFP 100 while the MFP 100 is in a logged-in state with an administrator logged in, thereby suppressing the unauthorized disclosure of User A's information. If User B seeks registration, and is confirmed that User B can log in to the MFP 100 as an administrator, User B is verified to be the legitimate administrator of the MFP 100. Therefore, it is considered acceptable to notify User B of the information about User A registered in association with the MFP 100.

In a hypothetical case where User B, who is the legitimate administrator, is unable to register for service 1 due to an existing registration by another user and cannot obtain information about the registered User A, User B may not know how to proceed. In such cases, User B might give up on using service 1.

According to the present embodiment, the system prevents User B from abandoning the use of service 1, thereby promoting the utilization of service 1. Furthermore, User B is not required to contact the provider of service 1 to inquire about how to use service 1 or to obtain information about the registered User A. This embodiment suppresses the occurrence of such inquiries, reducing the burden on the provider of service 1. As described above, this embodiment mitigates various inconveniences that may arise during the user registration process associated with the MFP 100.

Furthermore, according to this embodiment, the transfer token is assigned a validity period (S76 in FIG. 5) that is calculated from the time the serial number of the MFP 100 is received from User B (S62 in FIG. 5). The server 300 notifies the terminal device 200B of User A's information only if the transfer token is received from the MFP 100 within its validity period (S88 in FIG. 6) (S95 in FIG. 7). When the transfer token is received from the MFP 100 within the validity period that starts from the time the serial number of the MFP 100 is received, there is a very high likelihood that User B is the legitimate administrator of the MFP 100. This further suppresses the unauthorized disclosure of User A's information.

Furthermore, according to the present embodiment, the server 300 receives, along with the transfer token, login information from the MFP 100 indicating whether an administrator is logged in to the MFP 100 (S86 in FIG. 6). The server 300 notifies the terminal device 200B of User A's information (S95 in FIG. 7) only when login information indicating that an administrator is logged in to the MFP 100 is received along with the transfer token (S87 in FIG. 6). As a result, User A's information is notified to the terminal device 200B only when it is confirmed that an administrator is logged in to the MFP 100. This further prevents the improper disclosure of User A's information.

Furthermore, according to the present embodiment, during the subsequent registration process following the first registration process (FIGS. 5-7), the server 300 receives the user information for User B and the serial number of the MFP 100 via the terminal device 200B (S62 in FIG. 5, S100 in FIG. 7). When the registration request from User B is received, since the server 300 determines that the user registration for service 1 has already been completed in association with the MFP 100 (S64), the server 300 transmits the registration rejection notification screen W3 to the terminal device 200B, indicating that the User B's registration has been rejected (S66 in FIG. 5). After transmitting the registration rejection notification screen W3, the server 300 receives the transfer token from the MFP 100 while the MFP 100 is in the logged-in state (S86 in FIG. 6).

If the transfer token is received, the server 300 retrieves information about User A (e.g., the name of User A) from the management database DBs, by referencing the serial number associated with the transfer token in the device table DT and token table TT (S94 in FIG. 7). Additionally, the server 300 identifies (S102 in FIG. 7) the registration information containing the serial number of the MFP 100 associated with the transfer token (the record shown in FIG. 8A in the device table DT).

When particular authentication information is received, the server 300 updates the registration information in the management database DBs. Specifically, the record (FIG. 8A) is updated to a new record (FIG. 8B), associating User B with the MFP 100, thereby enabling completion of the registration for User B once all conditions are met (S103 in FIG. 7). Thus, the server 300 registers User B only if the serial number of the MFP 100 is received from User B after the registration of User A and the transfer token is received from the MFP 100 while it is in the logged-in state. This prevents issues where User B cannot register if User A is already registered with the MFP 100. As a result, this embodiment reduces the inconveniences that may occur during user registration associated with the MFP 100.

For example, in the present embodiment, only one user can be registered in association with the MFP 100 for a single service, and duplicate registrations are not allowed. In such a case, if User B inherits the MFP 100 from User A and is the legitimate owner of the MFP 100, but is unable to cancel User A's registration, User B cannot complete the registration for User B. If the system does not allow the cancellation of User A's registration, User B would be unable to use service 1, resulting in significant disadvantage to User B. When User B seeks registration and transmits the serial number of the MFP 100, and it is confirmed that User B can log in to the MFP 100 as an administrator, it is verified that User B is the legitimate administrator of the MFP 100. For this reason, if User B desires, it is considered acceptable to cancel the registration of User A, which is associated with the MFP 100.

Furthermore, according to the present embodiment, the transfer token is assigned the validity period (S76 in FIG. 5) that is calculated from the time the serial number of the MFP 100 is received from User B (S62 in FIG. 5). The server 300 executes the registration for User B only if the transfer token is received from the MFP 100 within the validity period (S88 in FIG. 6, S103 in FIG. 7). When the transfer token is received from the MFP 100 within the validity period starting from the time the serial number of the MFP 100 is received, there is a very high likelihood that User B is the legitimate administrator of the MFP 100. As a result, the system allows registration for User B only when User B is confirmed to be the legitimate administrator. This prevents cases where User A's registration could be improperly updated to another user's registration.

Furthermore, according to the present embodiment, the server 300 receives, from the MFP 100 along with the transfer token, login information indicating whether an administrator is logged in to the MFP 100 (S86 in FIG. 6). The server 300 executes the registration for User B only if the login information received along with the transfer token confirms that an administrator is logged in to the MFP 100 (S87 in FIG. 6, S103 in FIG. 7). As a result, User B's registration is executed only when it is confirmed that an administrator is logged in to the MFP 100. This further prevents improper updates of User A's registration to another user's registration.

As evident from the above description, in this embodiment, User A serves as an example of a first user, and User B serves as an example of a second user. The MFP 100 in this embodiment represents an example of an identifying device, and the serial number serves as an example of device identification information. The management database DBs in this embodiment represents an example of a storage medium, and the transfer token represents an example of particular authentication information.

### Second Embodiment

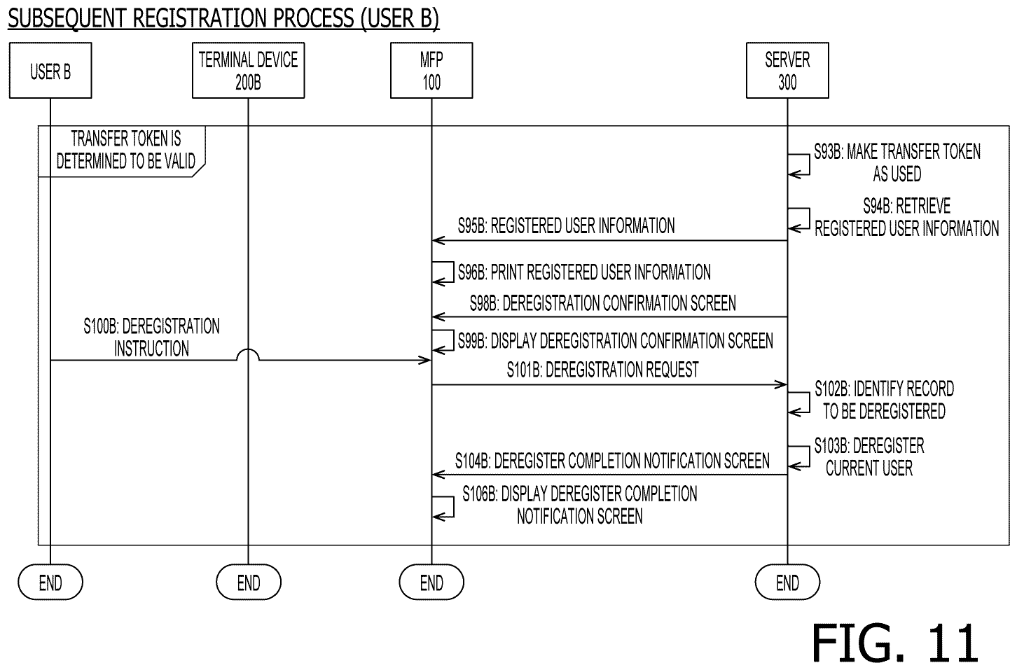

FIG. 11 illustrates a sequence diagram for the subsequent registration process in the second embodiment. In the second embodiment, the processing executed when the transfer token is determined to be valid differs from that in the first embodiment. In the first embodiment, when the transfer token is determined to be valid in S88 of FIG. 6, the processing in FIG. 7 is executed. However, in the second embodiment, when the transfer token is determined to be valid in S88 of FIG. 6, the processing shown in FIG. 11 is executed. Other processing in the second embodiment is identical to that in the first embodiment.

In S93B of FIG. 11, similar to S93 in FIG. 7, the server 300 changes the status of the transfer token to “used”. In S94B, similar to S94 in FIG. 7, the server 300 retrieves the registered user information.

In S95B, the server 300 transmits the retrieved registered user information to the MFP 100. As such, the registered user information may be sent to the terminal device 200B, as in the first embodiment, or to the MFP 100, as in the second embodiment. In the second embodiment, the registered user information is, for example, text data indicating the name of the registered user, such as User A.

When receiving the registered user information, the MFP 100 prints the registered user information in S96B. For example, the CPU 110 of the MFP 100 generates print image data that includes the registered user information and instructs the printing engine 170 to print an image based on the generated data. User B can view the printed registered user information on the paper and recognize the name of the registered user, such as User A. In a modified configuration, the registered user information may instead be displayed on the display of the MFP 100.

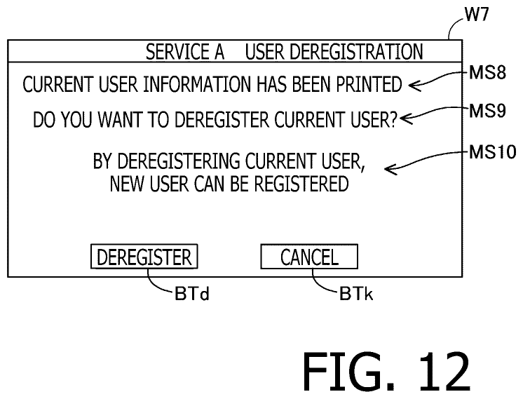

In S98B, the server 300 transmits the data for a deregistration confirmation screen W7 (see FIG. 12) to the MFP 100. When the MFP 100 receives the data for the deregistration confirmation screen W7, the MFP 100 displays the deregistration confirmation screen W7 on the display 140 in S99B using the received data.

FIG. 12 illustrates an example of the deregistration confirmation screen W7. The deregistration confirmation screen W7 includes a message MS8 notifying that the registered user information (e.g., the name of User A) has been printed. The deregistration confirmation screen W7 also includes a message MS9 asking whether to deregister the registered user, a message MS10 notifying that deregistering the current user will allow a new user to be registered, a deregister button BTd, which allows the input of a command to deregister the current user, and a cancel button BTk, which cancels the registration operation, and allows the input of a command to retain the registration of the current user.

If User B decides to retain the current user registration, the cancel button BTk is pressed. When the cancel button BTk is pressed, the MFP 100 terminates the display of the deregistration confirmation screen W7, and the subsequent registration process is interrupted (not shown in the drawings). If User B decides to proceed with deregistering the current user, the deregister button BTd is pressed.

When the deregister button BTd is pressed, the MFP 100 obtains a deregistration instruction in S100B. Upon obtaining the deregistration instruction, the MFP 100 transmits a deregistration request to the server 300 in S101B, requesting removal of the current user registration.

When receiving the deregistration request, the server 300 identifies the record to be deregistered in S102B. Specifically, the server 300 searches the device table DT for the record that contains the serial number associated with the transfer token (in this example, the serial number “DID_1” of the MFP 100), as shown in FIG. 8A.

In S103B, the server 300 removes the current user registration for service 1. Specifically, the registration of the user associated with the MFP 100, which is User A, is removed. For example, the server 300 deletes the entire record identified in FIG. 8A. Alternatively, in a modified example, the server 300 may remove the registration of User A by associating an invalidation flag with the record in FIG. 8A, instead of deleting the record entirely, to indicate that the record is no longer valid.

In S104B, the server 300 transmits data for a deregistration completion notification screen to the terminal device 200B. When receiving the data for the deregistration completion notification screen, the terminal device 200B displays the deregistration completion notification screen on its display in S106B. Although not illustrated, the deregistration completion notification screen includes a message indicating that the registration of the user previously associated with service 1 and the MFP 100 has been successfully removed.

Once the aforementioned subsequent registration process is completed, User B can again operate the terminal device 200B to perform the specified operations required for user registration for service 1. This causes the terminal device 200B to transmit a registration screen request to the server 300. In this case, the first registration process described with reference to FIG. 3 is executed to register User B. As a result, User B is registered as the user associated with service 1 for the MFP 100. Once the first registration process is completed, User B can utilize service 1 through the MFP 100.

In the embodiment described above, the recipient of the registered user information (e.g., the name of User A) is the MFP 100. In this case, the registered user information can be provided to User B, who is the administrator of the MFP 100. Additionally, because the registered user information is printed by the printing engine 170 of the MFP 100, User B can review the printed sheet to obtain information about the registered user.

Furthermore, in this embodiment, after the server 300 notifies the MFP 100 of the registered user information (i.e., the user information for User A), the server 300 receives a deregistration request transmitted from the MFP 100 based on an instruction from User B. Upon receiving the deregistration request, the server 300 modifies the registration information stored in the management database DBs (specifically, the device table DT) to deregister User A. If the deregistration request from User B is received and it is confirmed that User B can log in to the MFP 100 as an administrator, it is also verified that User B is the legitimate administrator of the MFP 100. Therefore, when a deregistration request is made by User B, it is considered acceptable to remove the registration of User A related to service 1 for the MFP 100. Additionally, because User B is able to deregister User A, User B can register themselves for service 1. This prevents the inconvenience where User B's registration cannot be completed due to the existing registration of User A.

While aspects of the present disclosure have been described in conjunction with various example structures outlined above and illustrated in the figures, various alternatives, modifications, variations, improvements, and/or substantial equivalents, whether known or presently unforeseen, may become apparent to those having at least ordinary skill in the art. Accordingly, the example embodiments of the disclosure, as set forth above, are intended to be illustrative of aspects of the present disclosure, and not limiting. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described aspects of the present disclosure are provided below.

(1) In the subsequent registration process of the above-described embodiment, the server 300, in S95 of FIG. 7, transmits the data for the update registration screen W6, which includes registered user information, to the terminal device 200B. As an alternative, the server 300 may transmit data for a registered user information notification screen containing only the registered user information to the terminal device 200B. In this case, for example, in S96 of FIG. 7, the terminal device 200B may display the registered user information notification screen, which includes details such as the name and contact email address of User A, and the subsequent registration process may then be terminated. In such a case, steps S98 through S106 of FIG. 7 would not be executed.

In such a case, User B can learn about the registered User A and, for example, contact User A to request the cancellation of User A's registration for service 1. Once User A's registration has been canceled through the appropriate procedure, User B can use the terminal device 200B to transmit the serial number of the MFP 100 to the server 300 (S12). This initiates the first registration process shown in FIG. 3, enabling the registration of User B for service 1.

(2) In the subsequent registration process of the above-described embodiment, the server 300 transmits data for the update registration screen W6, which includes the registered user information, to the terminal device 200B in S95 of FIG. 7. Alternatively, the server 300 may transmit data for the update registration screen W6 without including the registered user information to the terminal device 200B. In this case, S96 to S106 of FIG. 7 are still executed, and User B is registered for service 1. As a result, although User B is unable to obtain information about the registered User A, User B can still use the MFP 100 to access service 1. Additionally, this approach more reliably prevents the leakage of User A's information.

(3) In the subsequent registration process of the above-described embodiment, while the expiration date of the transfer token is set in S76 of FIG. 5, it is not strictly necessary that the expiration date is set. In such a case, the server 300 may receive, from the MFP 100, date and time information indicating when User B logged into the MFP 100, along with the transfer token. The server 300 may transmit the registered user information to the MFP 100 or the terminal device 200B only when the server 300 receives the date and time information indicating that User B logged into the MFP 100 within a particular period from the time when the server 300 received the serial number of the MFP 100 from the terminal device 200B.

Alternatively, the server 300 may transmit a one-time code (e.g., a 5 to 10-digit number) to the terminal device 200B upon receiving the serial number of the MFP 100 from User B. In this case, for example, User B may log into the MFP 100 and input the one-time code into the MFP 100. The server 300 may then receive the one-time code from the MFP 100, along with the transfer token. The server 300 may transmit the registered user information to the MFP 100 or the terminal device 200B only when the server receives the one-time code and the transfer token within a particular period from the time when the serial number of the MFP 100 was received from the terminal device 200B.

(4) In the subsequent registration process of the above-described embodiment, the server 300 transmits the registered user information to the terminal device 200B in S95 of FIG. 7 when login information indicating that an administrator is logged into the MFP 100 is received along with the transfer token in S87 of FIG. 6.

For example, if the MFP 100 is strictly controlled to ensure that the transfer token is transmitted externally only when an administrator is logged in, and is not transmitted when an administrator is not logged in, the MFP 100 may not need to transmit login information to the server 300. In this case, even if the server 300 receives the transfer token but does not receive login information, the server 300 may still transmit the registered user information to the terminal device 200B.

(5) The first registration process and the subsequent registration process described in the above embodiments are merely examples and may be modified as appropriate. For instance, the first registration process and the subsequent registration process may be executed collectively for multiple services.

Additionally, the terminal devices 200A and 200B execute the first registration process and the subsequent registration process by launching the browser program BP, using a web browser, and communicating with the server 300. Alternatively, the terminal devices 200A and 200B may execute the first registration process and the subsequent registration process by launching an application program provided by the operator of the services and using functions implemented by the application program to communicate with the server 300.

(6) In the above-described embodiment, the server 300 functions as the server providing services 1 through 4. Alternatively, a server other than the server 300 may provide services 1 through 4, and the server 300 may function solely as a server for managing user registration for the services.

(7) In the above embodiment, the first registration process and the subsequent registration process are performed by a single server, namely the server 300. Alternatively, the first registration process and the subsequent registration process may be implemented through a division of roles among two or more servers that are capable of communicating with each other. For example, a first server that communicates with the MFP 100 and a second server that communicates with the terminal devices 200A and 200B may collaborate to execute the first registration process and the subsequent registration process.

(8) In the above embodiment, portions of the configuration implemented by hardware may be replaced with software. Conversely, portions or all of the configuration implemented by software may be replaced with hardware.

What is claimed is:

1. A communication system, comprising:
a first terminal device to be used by a first user;
a second terminal device to be used by a second user;
a particular device; and
a server provided with a storage device and communicatively connected to the first terminal device, the second terminal device and the particular device,
wherein the server comprises a controller having hardware, the controller being configured to perform:
receiving, from the first terminal device, first user information that is information about the first user and device identification information identifying the particular device;
registering the first user by storing registration information associating the first user information and the device identification information in the storage device in response to receiving the first user information and the device identification information from the first terminal device;
storing particular authentication information in association with the device identification information in the storage device when the first user is to be registered;
transmitting the particular authentication information to the particular device when the first user is to be registered;
receiving the device identification information from the second terminal device after registration of the first user;
transmitting, to the second terminal device, a rejection notification indicating that registration of the second user using the second terminal device that transmitted the device identification information is rejected in response to the device identification information being received from the second terminal device after registration of the first user;
receiving the particular authentication information from the particular device that is in a logged-in state, the logged-in state being a state where an administrator is logged in to the particular device using administrator information that is not stored in the storage device of the server;
obtaining the first user information associated with the device identification information in response to the particular authentication information being received, the device identification information being associated with the particular authentication information in the storage device; and
notifying the first user information obtained in the obtaining to a particular notification destination in response to the particular authentication information being received.

2. The communication system according to claim 1,
wherein a validity period starting from a time when the device identification information is received from the second terminal device is set to the particular authentication information, and
wherein the notifying notifies the first user information obtained in the obtaining to the particular notification destination in response to the particular authentication information being received from the particular device within the validity period.

3. The communication system according to claim 2,
wherein the particular notification destination is the particular device,
wherein the particular device comprises at least one of a display or a printer, and
wherein the notifying transmits a notification including the first user information to the particular device to cause at least the display to display the first user information or the printer to print the first information.

4. The communication system according to claim 2,
wherein the particular notification destination is the particular device, and
wherein the controller of the server is further configured to perform:
receiving a deregistration request from the particular device after the first user information is transmitted to the particular device, the deregistration request being a request transmitted based on an instruction by the second user to deregister the first user; and
changing the registration information stored in the storage device so that the first user is deregistered in response to receiving the deregistration request.

5. The communication system according to claim 3,
wherein the controller is configured to receive login information indicating whether an administrator is logged in to the particular device together with the particular authentication information, and
wherein the notifying notifies the particular notification destination of the first user information in response to the controller receiving the login information indicating that the administrator is logged in to the particular device.

6. A communication system, comprising:
a first terminal device used by a first user;
a second terminal device used by a second user;
a particular device; and
a server including a storage device and configured to be communicatively connected to the first terminal device, the second terminal device and the particular device,
wherein the server comprises a controller having hardware, the controller being configured to perform:
receiving, from the first terminal device, first user information that is information about the first user, and device identification information identifying the particular device;
registering the first user by storing registration information associating the first user information and the device identification information in the storage device in response to receiving the first user information and the device identification information from the first terminal device;
storing the particular identification information in association with the device identification information in the storage device when the first user is to be registered;
transmitting the particular identification information to the particular device when the first user is to be registered;
receiving the device identification information from the second terminal device after registration of the first user;
transmitting, to the second terminal device, a rejection notification indicating that registration of the second user using the second terminal device that transmitted the device identification information is rejected in response to the device identification information being received from the second terminal device after registration of the first user;
receiving the particular authentication information from the particular device that is in an administrator login state, the administrator login state being a state where an administrator is logged in to the particular device using administrator information that is not stored in the storage device of the server;
identifying the registration information including the device identification information that is associated with the particular authentication information in the storage device in response to the particular authentication information being received; and
registering the second user by updating, in the storage device, the registration information identified in the identifying to updated registration information in which the second user information is associated with the device identification information in response to the particular authentication information being received.

7. The communication system according to claim 6,
wherein a validity period starting from a time when the device identification information is received from the second terminal device is set to the authentication information, and
wherein the controller is configured to register the second user using the second terminal device in response to the particular authentication information being received from the particular device within the validity period.

8. The communication system according to claim 6,
wherein the controller is configured to perform:
receiving login information indicating whether an administrator is logged in to the particular device together with the particular authentication information, and
registering the second user using the second terminal device in response to the login information indicating whether the administrator is logged in to the particular device being received.

9. A server including a storage device and configured to be communicatively connected to a first terminal device to be used by a first user, a second terminal device to be used by a second user, a particular device, and a controller having hardware,
wherein the controller is configured to perform:
receiving, from the first terminal device, first user information that is information about the first user, and device identification information identifying the particular device;
registering the first user by storing registration information associating the first user information and the device identification information in the storage device in response to receiving the first user information and the device identification information from the first terminal device;
storing the particular identification information in association with the device identification information in the storage device when the first user is to be registered;
transmitting the particular identification information to the particular device when the first user is to be registered;
receiving the device identification information from the second terminal device after registration of the first user;
transmitting, to the second terminal device, a rejection notification indicating that registration of the second user using the second terminal device that transmitted the device identification information is rejected in response to device identification information being received from the second terminal device after registration of the first user;
receiving the particular authentication information from the particular device that is in a login state, the login state being a state where an administrator is logged in to the particular device using administrator information that is not stored in the storage device of the server;
obtaining the first user information associated with the device identification information in response to the particular authentication information being received, the device identification information being associated with the particular authentication information in the storage device; and
notifying the first user information obtained in the obtaining to a particular notification destination in response to the particular authentication information being received.

10. A server including a storage device and configured to be communicatively connected to a first terminal device to be used by a first user, a second terminal device to be used by a second user, a particular device, and a controller having hardware,
wherein the controller is configured to perform:
receiving, from the first terminal device, first user information that is information about the first user, and device identification information identifying the particular device;
registering the first user by storing registration information associating the first user information and the device identification information in the storage device in response to receiving the first user information and the device identification information from the first terminal device;
storing the particular identification information in association with the device identification information in the storage device when the first user is to be registered;
transmitting the particular identification information to the particular device when the first user is to be registered;
receiving the device identification information from the second terminal device after registration of the first user;
transmitting, to the second terminal device, a rejection notification indicating that registration of the second user using the second terminal device that transmitted the device identification information is rejected in response to the device identification information ben received from the second terminal device after registration of the first user;
receiving the particular authentication information from the particular device that is in an administrator login state, the administrator login state being a state where an administrator is logged in to the particular device using administrator information that is not stored in the storage device of the server;
identifying the registration information including the device identification information that is associated with the particular authentication information in the storage device in response to the particular authentication information being received; and
registering the second user by updating, in the storage device, the registration information identified in the identifying to updated registration information in which the second user information is associated with the device identification information in response to the particular authentication information being received.
